(19) United States
(12) Patent Application Publication
(10) Pub. No.: US 2013/0064389 A1
(43) Pub. Date: Mar. 14, 2013

(54) SYSTEM AND APPARATUS FOR MODULAR ON-DEMAND AUDIO PROCESSING, AMPLIFICATION AND DISTRIBUTION

(71) Applicant: Logan Daniel JACOBS, St. Albert (CA)

(72) Inventor: Logan Daniel JACOBS, St. Albert (CA)

(21) Appl. No.: 13/594,504

(22) Filed: Aug. 24, 2012

Related U.S. Application Data
(60) Provisional application No. 61/532,800, filed on Sep. 9, 2011.
(60) Provisional application No. 61/691,748, filed on Aug. 21, 2012.

(51) Int. Cl. H04R 1/02

(52) U.S. Cl. 381/87

(57) ABSTRACT

The present disclosure relates to a system for processing, amplification and distribution of audio signals. In an embodiment, the system comprises: a panel or housing having one or more slots configured to receive one or more modular audio processor/amplifier units therein; and a connector provided in each slot for connecting the one or more modular audio processor/amplifier units upon insertion of a unit into the slot; wherein the one or more modular audio processor/amplifier units inserted into the plurality of slots are connected to a power source thereby, and to corresponding listening zones associated with each slot.

### CROSS-REFERENCE TO RELATED APPLICATIONS

The present application claims the benefit of U.S. application Ser. No. 61/532,8400 filed on. Sep. 9, 2011, and U.S. application Ser. No. 61/691,748 filed on Aug. 21, 2012, the entirety of which are incorporated herein by reference,

### FIELD

The present disclosure relates generally to an audio processing, amplification and distribution system and apparatus.

### BACKGROUND

Over the years, various audio distribution systems have been developed for use in homes and buildings to broadcast audio over multiple listening zones, such as rooms or other living spaces, both on the interior and exterior of homes and buildings. As an illustrative example, U.S. Pat. No. 5,255,322 issued to Farinelli et al., discloses a multi-zone audio distribution amplifier system having a housing to store modular, cascadable amplifier units, Each amplifier unit includes an input port for receiving an input stereo signal, at least one amplifier circuit to amplify the input signal, and an output port for providing access to the amplified stereo signal. Speakers in various rooms receive the amplified signal from their respective amplifier in the housing. With the Farinelli et al, system, each amplifier is dedicated to amplifying an audio input signal for playback in a listening zone via dedicated speakers.

While the Farinelli et is system may be suitable for applications where an audio signal is generally distributed to all zones at the same time, or particular audio inputs are generally directed to particular audio outputs, this prior art audio distribution system may be less than optimal when considerable flexibility is required for directing a number of audio sources to different zones.

Furthermore, the proliferation of smart phone and wireless tablet, devices has changed the way in which digital entertainment, music, and communication can be conveniently accessed and played back in home and business audio systems. Additionally, because of the mass proliferation of wireless home and business networks, what is needed is an improved audio distribution system with greater configuration flexibility which may overcome some of the limitations of the prior art.

What is needed is an improved audio distribution system with greater configuration flexibility which may overcome some of the limitations of the prior art,

### SUMMARY

The present disclosure is related to a system and apparatus for modular on-demand audio processing, amplification and distribution which may be configured to receive and process wireless or wired audio input signals from one or more audio sources; amplify on-demand the one or more processed audio input signals using one or more amplifiers; and distribute the processed and optionally amplified audio signals for playback via one or more speakers in one or more listening zones.

In an aspect, there is provided a modular system for processing, amplification and distribution of audio signals, comprising: a panel or housing having one or more slots configured to receive one or more modular audio processor/amplifier units therein; and a connector provided in each slot for connecting the one or more modular audio processor/amplifier units upon insertion of a unit into the slot; wherein the one or more modular audio processor/amplifier units inserted into the plurality of slots are connected to a power source thereby, and to corresponding listening zones associated with each slot.

In an embodiment, the connector provided in each slot is adapted to provide a power connection, a ground connection, and one or more signal connections for each modular audio processor/amplifier unit connected thereto.

In another aspect, there is provided a wall mountable apparatus for an audio processing, amplification and distribution system, comprising: one or more slots configured to receive one or more modular audio processor/amplifier units therein; and a connector provided in each slot for connecting the one or more modular audio processor/amplifier units upon insertion of a unit into the slot; wherein the one or more modular audio processor/amplifier units inserted into the plurality of slots are connected to a power source thereby, and to corresponding listening zones associated with each slot.

The one or more modular audio processor/amplifier units may be configured to be normally on standby in the absence of an audio input signal, and to process and optionally amplify any audio input signals on-demand upon receipt of an audio signal or wake signal directed or addressed to the one or more modular audio processor/amplifier units. The processed audio signals are then distributed to one or more speakers in one or more listening zones in various ways.

In this respect, before explaining at least one embodiment of the system and apparatus of the present disclosure in detail, it is to be understood that the present system and apparatus is not limited in its application to the details of construction and to the arrangements of the components set forth in the following description or illustrated in the drawings. The present system and apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic block diagram of an audio processing, amplification and distribution system in accordance with an embodiment;

FIGS. 2A-2C show illustrative views of a panel housing for a modular audio processing, amplification and distribution system in accordance with an embodiment;

FIGS. 3A-3E show illustrative views of a panel housing for a modular audio processing, amplification and distribution system in accordance with another embodiment;

FIGS. 4A-4C show illustrative detailed views of an audio processor/amplifier module in accordance with an embodiment;

FIGS. 5A-5D show illustrative detailed views of the panel housing in accordance with an embodiment;

FIGS. 6A-6G show illustrative views of the panel housing being mounted to a wall, and audio processor/amplifier modules being inserted in available slots in the panel housing in accordance with an embodiment.

### DETAILED DESCRIPTION

As noted above, the present disclosure is related to a system and apparatus for modular on-demand audio processing, amplification and distribution which may be configured to receive and process wireless or wired audio input signals from one or more audio sources; amplify on-demand the one or more processed audio input signals using one or more amplifiers; and distribute the processed and optionally amplified audio signals for playback via one or more speakers in one or more listening zones,

In an embodiment, the system and apparatus may operate in a network environment such as within a Wi-Fi computer network hot spot set up in a home or a building.

In another embodiment, the system includes an audio processor/amplifier panel or housing which may accept one or more modular amplification units, The one or more modular amplifier units may be configured to be normally on standby in the absence of an audio input signal, and to amplify any audio input signals on-demand upon receipt of an audio signal or wake signal directed or addressed to the one or more modular amplifier units, The amplified audio signals are then distributed to one or more speakers in one or more listening zones via a suitable audio out multi-switch, in an embodiment, the audio out multi-switch may be configured to be controllable by logic to allow any one of the modular amplifier units to direct its amplified audio signal to any one of the listening zones via the one or more speakers.

In another embodiment, the system includes an audio processor/amplifier panel or housing which may accept one or more modular audio processor/amplifier units. The one or more modular audio processor/amplifier units may be configured to be normally on standby in the absence of an audio input signal, and to process and optionally amplify any audio input signals on-demand upon receipt of an audio signal or wake signal directed or addressed to the one or more modular audio processor/amplifier units. The processed audio signals are then distributed to one or more speakers in one or more listening zones in various ways.

In one embodiment, the one or more speakers in the one or more listening zone are connected conventionally using speaker wire, in this embodiment, the processed audio signals are also amplified for output to the one or more speakers connected using speaker wire.

In another embodiment, the one or more speakers in the one or more listening zones are self powered speakers which are connected wirelessly to the audio processor/amplifier panel, such that there is no need to connect the speakers to the amplifier speaker connections using speaker wire. Rather, in this embodiment, the system pairs each wireless speaker to a digital line output which bypasses the amplification stage of the one or more audio processor/amplifier units. Line outputs from one or more audio processor/amplifier units are connected to a wireless audio signal transmitter, and received by one or more of the self-powered, wirelessly connected speakers.

In another embodiment, the one or more speakers are connected to the audio processor/amplifier panel via a power line, such that a digital audio signal is transmitted over the power line from the audio processor/amplifier panel to a speaker with a digital audio signal receiver which receives the digital audio signal and converts it to an analog audio signal for amplification and playback via the power line connected speaker. In this embodiment, the audio signal once again bypasses the amplification stage of the audio processor/amplifier module.

In another embodiment, the one or more speakers are connected to the audio processor/amplifier panel via more than one connecting means. For example, left and right channel speakers may be connected by speaker wires or by a wireless connection, and a subwoofer connected via a power line. Any combination of connections is possible.

In another embodiment, the audio processor/amplifier panel further includes a wireless transceiver, such as Wi-Fi, allowing connection of the audio processor/amplifier panel to the Internet. With this embodiment, the audio processor/amplifier panel may be configured as an Internet radio for receiving any one of numerous Internet radio transmissions. In an embodiment, the audio processor/amplifier panel may be configured to direct more than one Internet radio transmission simultaneously through different audio processor/amplifier panels, such that speakers in different audio listening zones may be outputting sound from different Internet audio stations.

In another embodiment, the audio processor/amplifier panel further includes a wireless transceiver, such as Wi-Fi, allowing connection of the audio processor/amplifier panel to the Internet. With this embodiment, the audio processor/amplifier panel may be configured as an Internet radio for receiving any one of numerous Internet radio transmissions. In an embodiment, the audio processor/amplifier panel may be configured to direct more than one Internet radio transmission simultaneously through different audio processor/amplifier panels, such that speakers in different audio listening zones may be outputting sound from different Internet audio stations.

In another embodiment, each modular audio processor/amplifier unit may include a wireless transceiver, such as allowing connection of the audio processor/amplifier unit to the Internet. With this embodiment, the audio processor/amplifier modular unit may be configured as an Internet radio for receiving any one of numerous Internet radio transmissions.

The system and apparatus the present disclosure allows audio signals to be amplified and distributed to multiple listening zones with greater flexibility than was possible with earlier designs. By providing a modular, scalable design for adding modular amplifier units, the system can also be suitably sized and configured for the number of listening zones that the system needs to support. The modular amplifier units can also be removed if there is excess or redundant capacity to be used in another compatible audio distribution system.

By providing significant flexibility in building different configurations, it is believed that the present modular audio distribution system may help to stimulate the installation of audio distribution systems in new building construction and may also help to stimulate the development of compatible audio processor/amplifier modules that can be installed in a modular fashion and implemented on a wide scale in commercial and residential audio amplification and distribution applications.

The system and apparatus will now be described in more detail with reference to the drawings. It will be understood, however, that the drawings and the accompanying description illustrate just one possible embodiment, and different embodiments are possible.

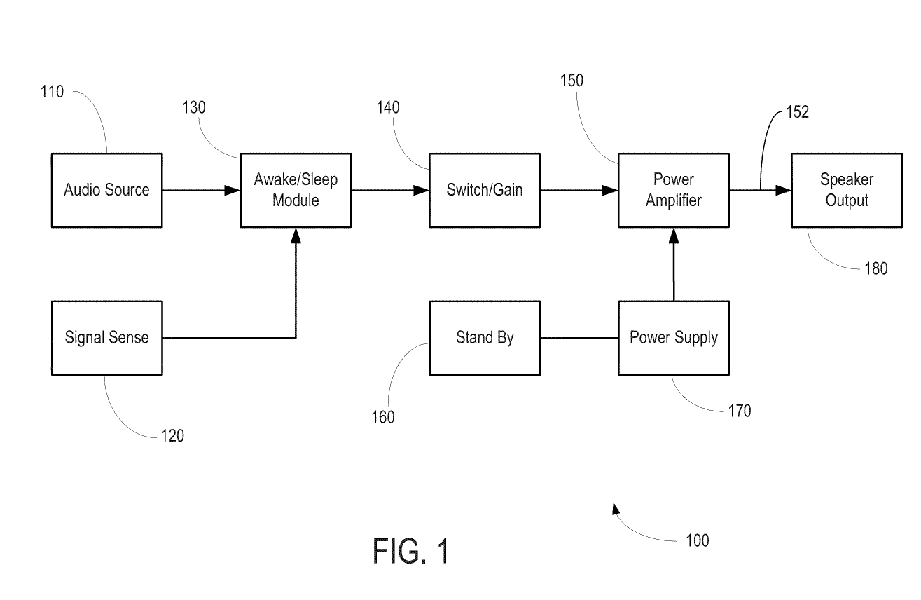

Now referring to FIG. 1, shown is a schematic block diagram of an amplification system in accordance with an embodiment. As shown, FIG. 1 illustrates an audio source 110 which may provide a wired or wireless audio input signal. As an illustrative example, the audio source 110 may be an existing wireless digital audio transmission technology, such as AirPlay™ offered by Apple™.

The audio input signal is received by an wake sleep module 130 which may receive an input from a signal sensing module 120 that an audio input signal is present. Signal sensing module 120 may be a separate module, or integrated within another module as desired. Awake/sleep module 130 may be configured to switch from a sleep mode to an awake mode in the presence of an audio input signal to switch on power amplifier 150 and increase the gain 140 of the audio input signal for amplification by power amplifier 150, Power amplifier 150 draws power from a power supply 170 which may remain in a standby state 160 until power is required by the power amplifier 150 to amplify the audio input signal. As shown, the amplified audio signal is output via conductive speaker wires 152 to positive and negative terminals of a pair of speaker outputs 180 to drive them. Gain 140 may be adjusted to control the volume of the speakers in a given audio listening zone.

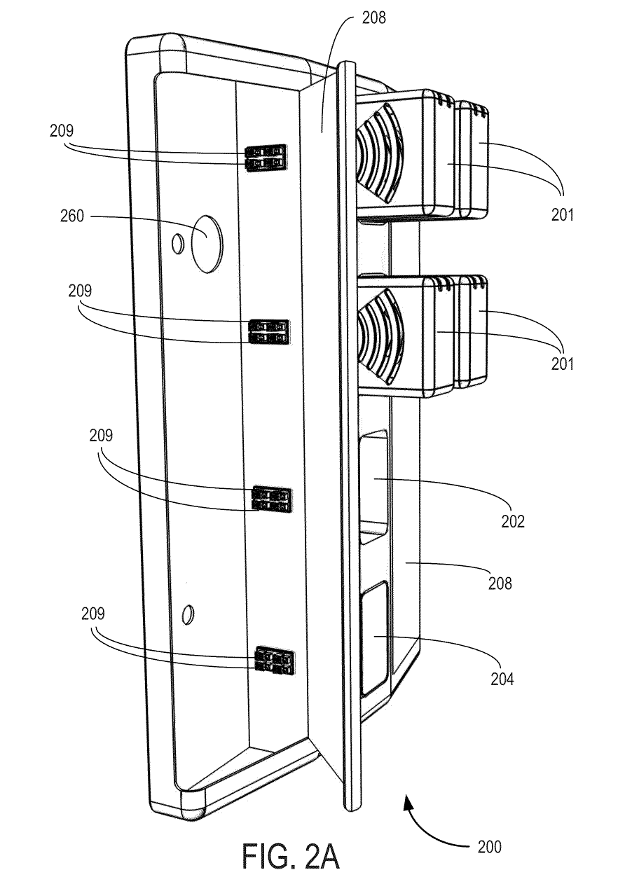

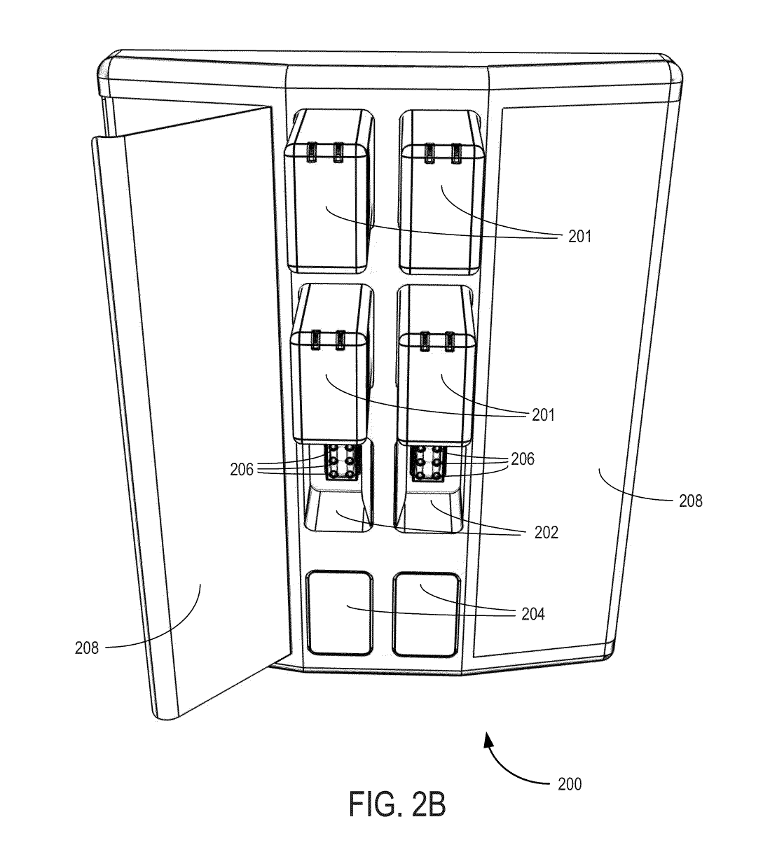

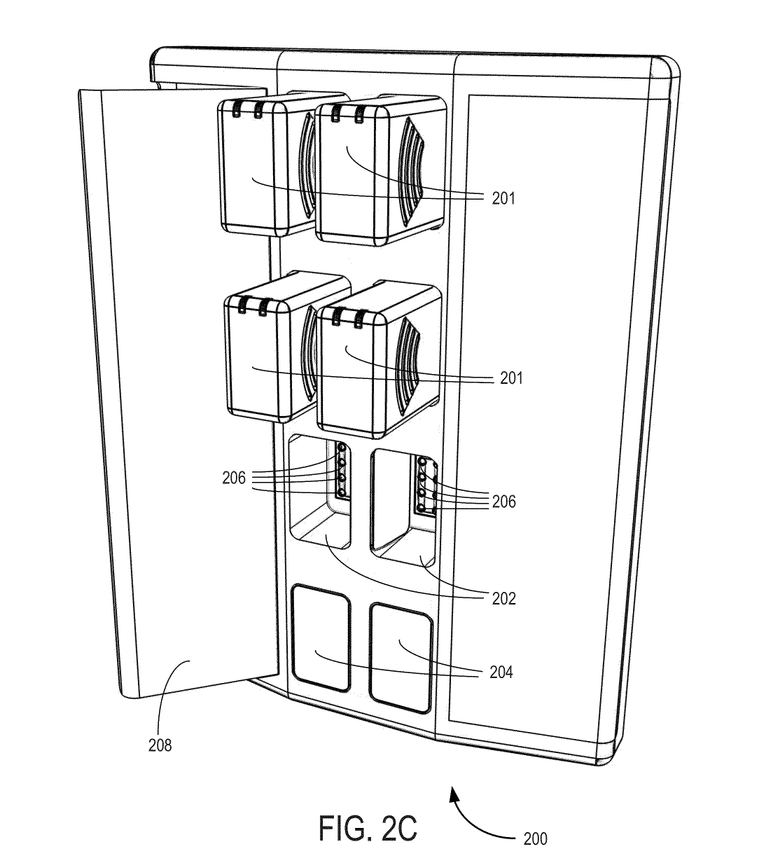

Now referring to FIGS. 2A-2C, shown is an illustrative diagram of a panel housing for a processing, amplification and distribution system in accordance with an embodiment. As shown, the panel housing embodies a modular audio processing, amplification and distribution system 200, which may include one or more modular processor/amplifier units 201. As shown, a plurality of modular processor/amplifies units 201 may be installed in the panel. For example, the modular processor/amplifier units 201 may be inserted into slots 202 which may optionally be covered by covers 204, When fully inserted within slots 202, the modular processor/amplifier units 201 may be connected to the panel via a plurality of connectors 206.

In an embodiment, each connector 206 provided in each slot 202 is adapted to provide a power connection, a ground connection, and one or more signal connections for each modular processor/amplifier units 201 connected thereto.

In a preferred embodiment, the modular processor/amplifier units 201 are of a standard size, with standard connection points to the plurality of connectors 206. Not all connectors 206 need to have an active connection to the modular processor/amplifier units 201 if not required.

In an embodiment, the plurality of slots are sized identically to interchangeably receive any one of one or more identically sized modular audio processor/amplifier units therein. Alternatively, in another embodiment, the plurality of slots are sized differently to receive only certain appropriately sized modular audio processor/amplifier units therein.

In an embodiment, the panel housing may further include hinged doors 208 providing access to a plurality of speaker connection points 209 for a plurality of speakers. In an embodiment, these plurality of speaker connection points 209 may comprise standard speaker wire connections for connecting the negative and positive terminals of speaker wires.

In another embodiment, the modular audio processing, amplification and distribution system 200 may be connected to a plurality of speakers via conductive wires 152 connected to speakers (not shown) via a wiring conduit. The wiring conduit may connect speakers in multiple audio listening zones through wall spaces and ceiling spaces to connect all speakers to the modular audio processing, amplification and distribution system 200.

In an illustrative embodiment, the modular audio processing, amplification and distribution system 200 may be configured in a manner somewhat similar to an electrical panel distribution system in a typical house hold, except that the system accepts modular amplifier units that amplify and distribute an audio signal throughout a home or a building to audio speakers. In an embodiment, the electrical wiring in a house or building may be used to connect the audio processing, amplification and distribution system 200 to self-amplified speakers connected via various electrical outlets.

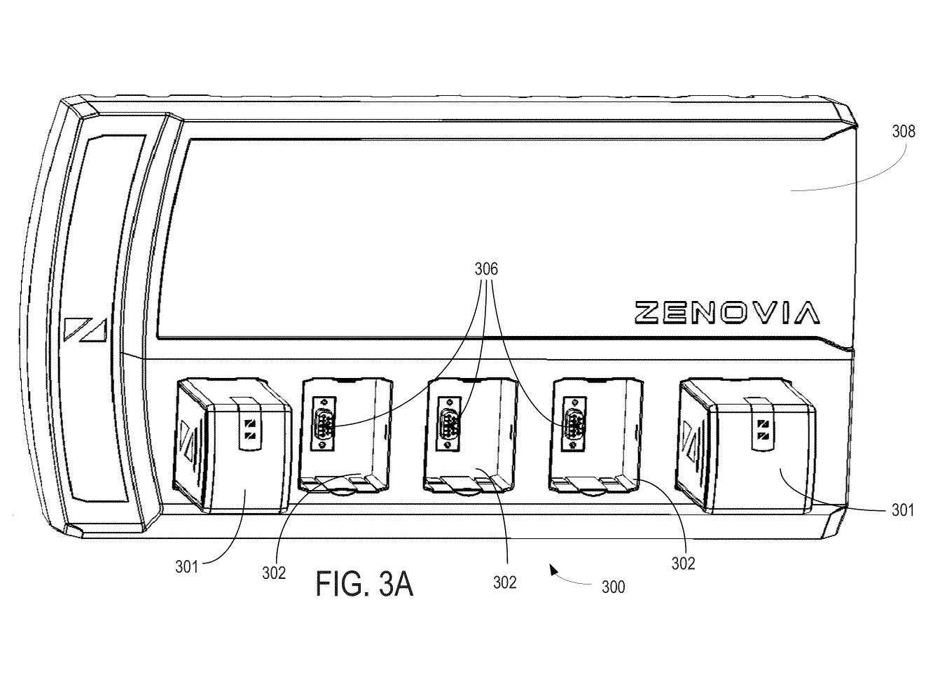

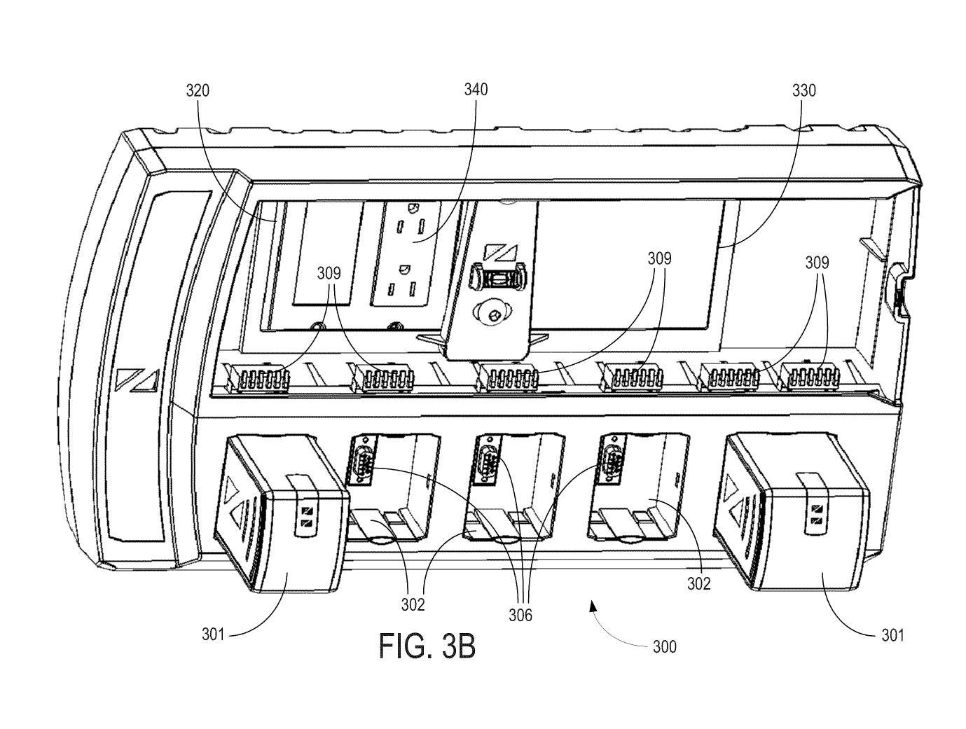

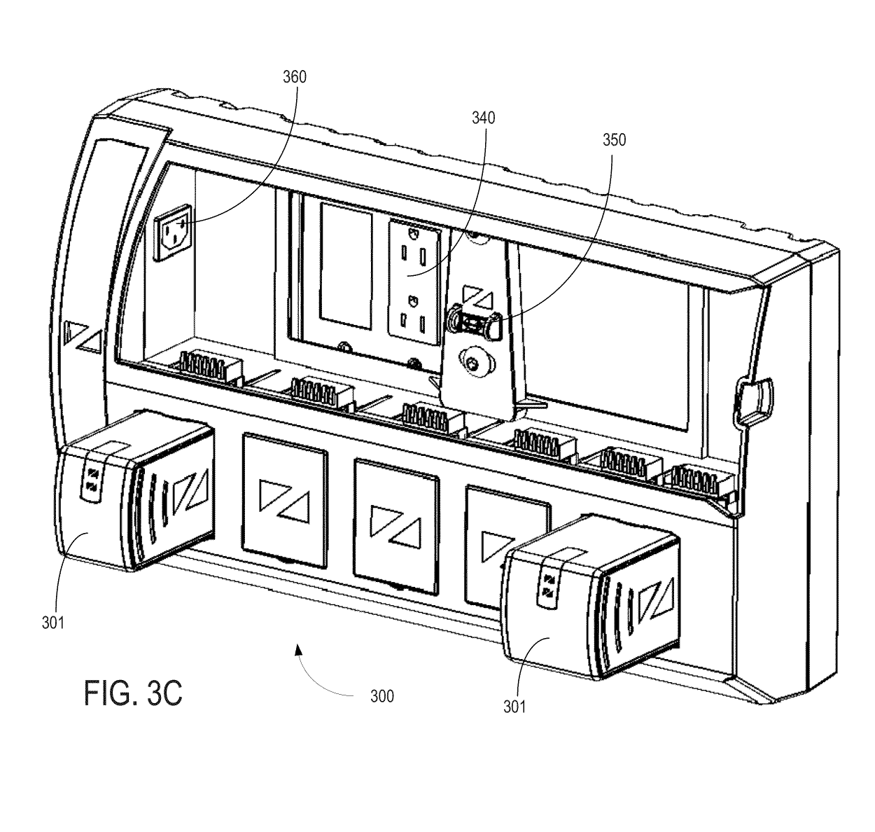

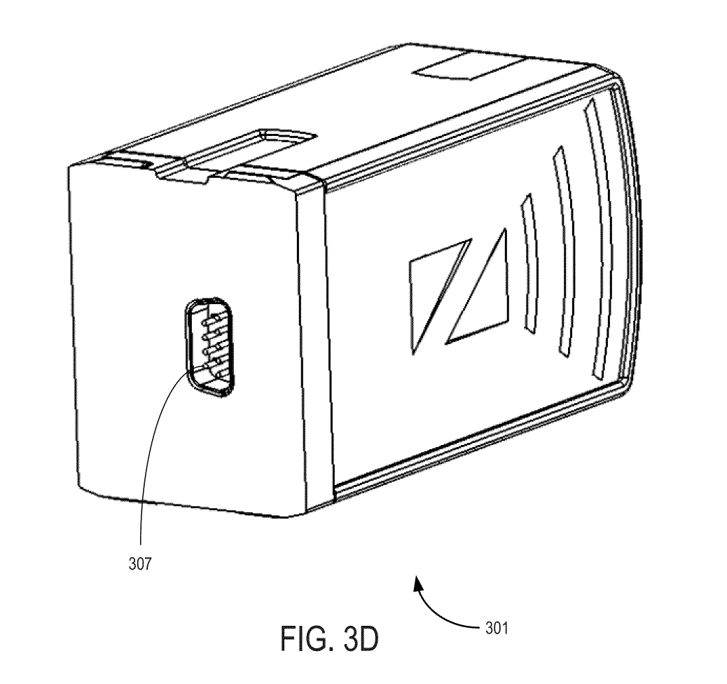

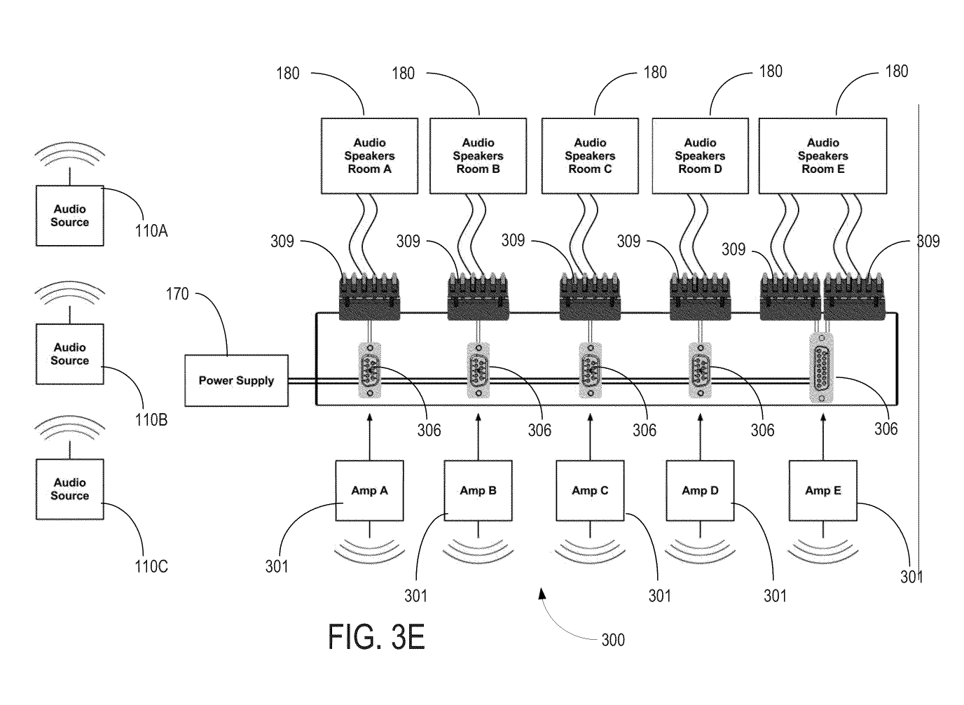

FIGS. 3A-3D show illustrative views of a panel housing for a modular audio processing, amplification and distribution system in accordance with another embodiment. As shown, the panel housing embodies a modular audio processing, amplification and distribution system 300 which may include one or more modular processor/amplifier units 301. A plurality of modular processor/amplifier units 301 may be installed in the panel. When fully inserted within slots 302, the modular processor/amplifier units 301 may be connected to the panel via a plurality of connectors 306.

In a preferred embodiment, the modular processor/amplifier units 301 are of a standard size, such that they are interchangeable within the slots 302. The modular processor/amplifier units 301 include connection points configured to connect to the plurality of connectors 300. In an illustrative embodiment, connectors 306 comprise a plug-in connector such that the modular processor/amplifier units 301 may be connected to the processing, amplification and distribution system 300 by fully inserting the modular processor/amplifier units 301 into a slot.

In one embodiment, the plug-in connector may be adapted from a standard connector which is modified to allow the pins to carry signals between the modular processor/amplifier units 301 and the processing, amplification and distribution system 300. By way of example, and not by way limitation, the plug-in connector may be physically adapted from a multi-pin and socket connector such as a standard DB-9 pin and socket connector. Various other types of standard connectors, such as DB-15 or DB-25, may be modified such that the pins carry various signals between the modular processor/amplifier units 301 and the processing, amplification and distribution system 300.

Advantageously, by utilizing a standard pin and socket connector type, and adapting the wiring as necessary for the present application, the connection of the modular processor/amplifier units 301 to the processing, amplification and distribution system 300 is simplified, and the costs for producing the connectors 306 can be minimized. Furthermore, the standard connectors 206 allow the modular processor/amplifier units 301 to be readily interchanged between slots 302.

FIG. 3B shows another view of the processing, amplification and distribution system 300, in which a cover panel has been removed to show additional details. As shown, the processing, amplification and distribution system 300 may be configured to include access openings 320, 330 which allow the processing, amplification and distribution system 300 to be mounted adjacent an electrical outlet 340, The access openings 320, 330 further provide access to drill into a wall in order to allow connections of speaker cables running to the processing, amplification and distribution system 300 from different listening zones. Speaker cables (not shown) may then be connected to one of a plurality of speaker cable connection points 300.

Significantly, each speaker cable connection point 309 is clearly associated with on of the slots 302.

As shown in FIG. 3C in another view of the processing, amplification and distribution system 300, a level 350 may be used to squarely mount the processing, amplification and distribution system 300 against a wall using screws or other fastening means. A connector for a power outlet 360 allows a connection point for power to the processing, amplification and distribution system 300.

FIG. 3D shows an enlarged view of an illustrative modular processor/amplifier units 301, in which a pin connector 307 is suitably configured and used as a connection point to match with any one of connectors 306. By providing a common physical configuration for the modular processor/amplifier units 301, the modular processor/amplifier units 301 can be inserted into any slot to be connected to any one of the connectors 20$ on the processing, amplification and distribution system 300.

In an embodiment, each modular processor/amplifier unit 301 includes a wireless transceiver, such that each modular processor/amplifier unit 301 is directly addressable from a wireless remote controller or wireless device.

In another embodiment, each modular processor amplifier unit 301 includes an awake/sleep module (as described earlier), such that each modular processor/amplifier unit 301 is individually addressable to switch the modular processor/amplifier unit 301 between a sleep mode and an awake mode. In sleep mode, a minimal amount of power is provided to the awake/sleep module and other necessary modules to maintain sleep mode until a signal is received to s den the modular processor/amplifier unit 301 to an awake mode. In awake mode, full power is accessible by the modular processor/amplifier unit 301 to process and amplify any digital audio signal received from an audio source.

Now referring to FIG. 3, shown is a schematic block diagram of another illustrative modular architecture for the panel housing for the modular audio processing, amplification and distribution system of FIGS. 3A-3D. As shown, in, this illustrative embodiment, a plurality of modular processor/amplifier units 301 may be plugged into any one of the available connectors 306. A power supply 170 provides power to all modular processor/amplifier units 301 that are plugged into the processing, amplification and distribution system 300. As shown in FIG. 3E with cover panel 303 removed, the connectors 306 provide a signal path for connection to speaker wire connectors 309, which are in turn connected to audio speakers 130 located in different listening zones.

In an embodiment, the plurality of speaker cable connection points are adapted to receive pre-installed speaker wires from a plurality of listening zones, such that the processing, amplification and distribution system 300 can centrally provide processing, amplification and distribution to all listening zones.

Still referring to FIG. 3E, a number of audio sources 110A-110C may broadcast wireless signals to different modular processor/amplifier units 301, each of which may be individually addressed to receive a wireless signal from the audio sources 110A-110C. One audio source can address many modular processor/amplifier units 301 simultaneously if it is desired to direct the audio signal to different listening zones simultaneously.

As illustrated above, speakers in different listening zones may be wired to the panel/housing. In an embodiment, without any modules, no amplification or audio playback is possible, and the speakers remain inactive. The audio zones are only activated or enabled with the insertion of an amplifier module. Thus, the modular audio processor/amplifier units complete an audio circuit and allow the speakers to be engaged when the audio processor/amplifier unit is awoken.

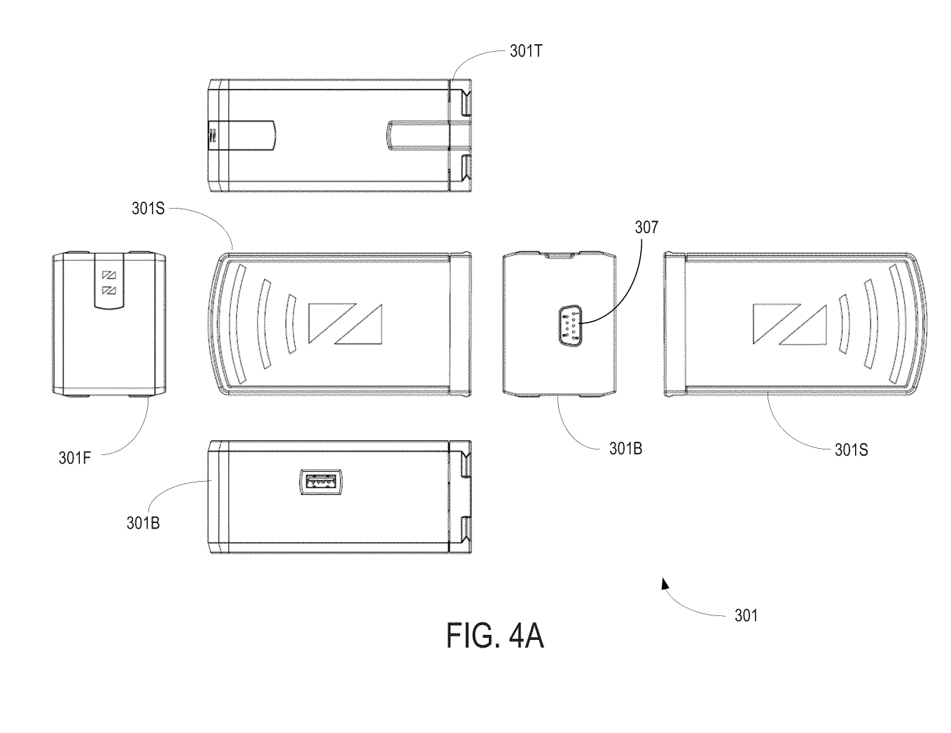

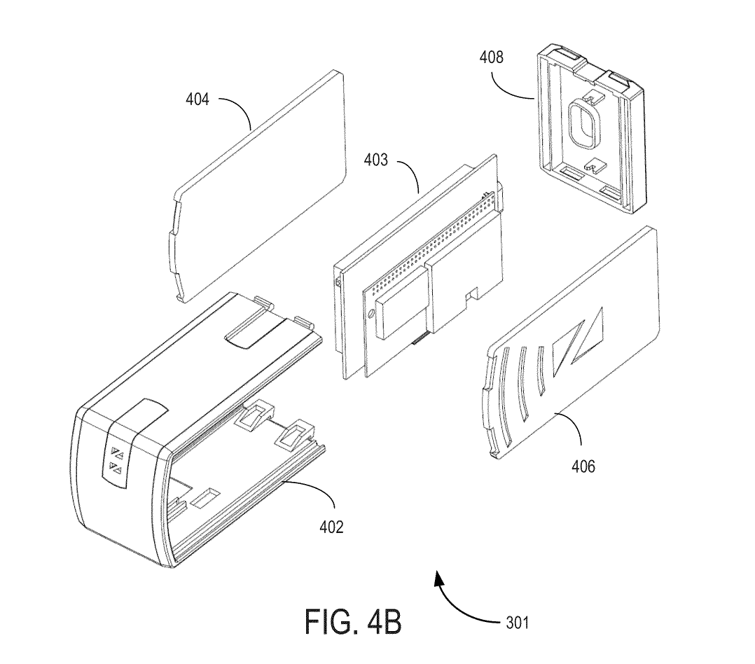

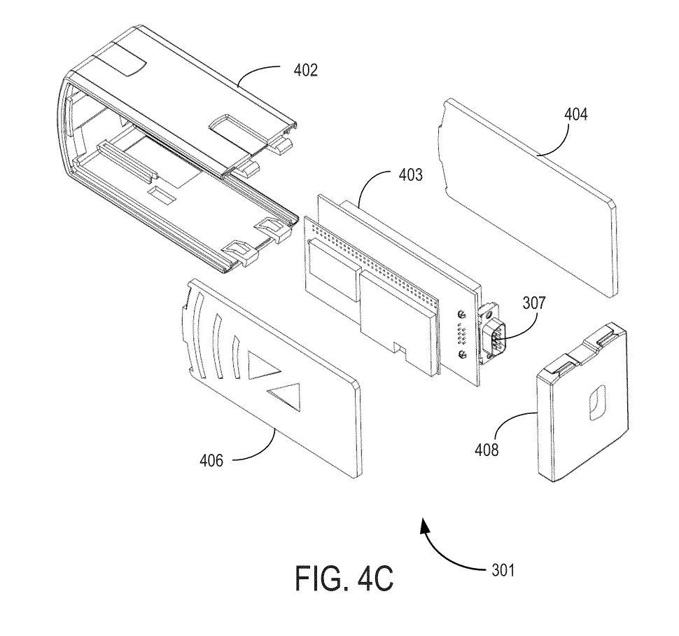

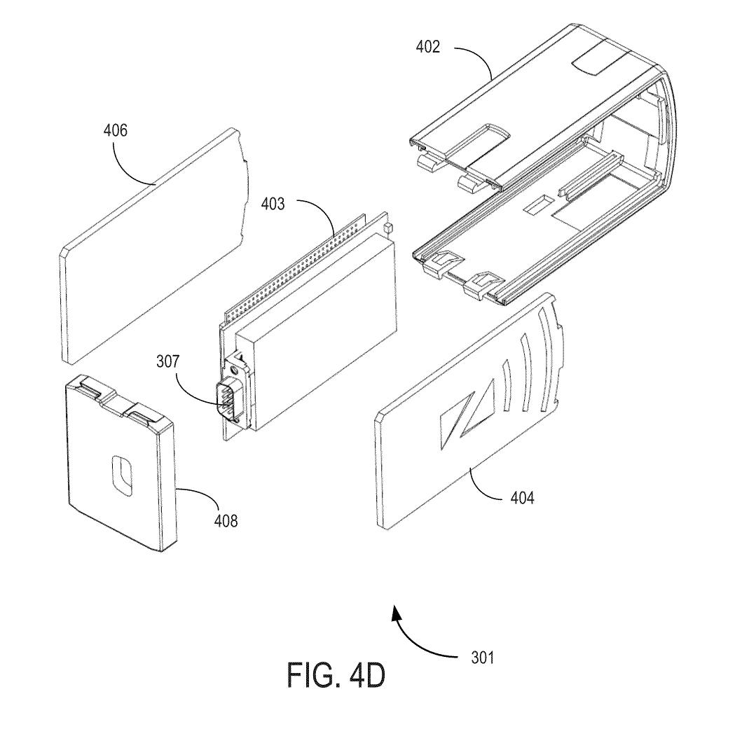

Now referring to FIGS. 4A-4D, shown are illustrative detailed views of an audio processor/amplifier module in accordance with an embodiment. In FIG. 4A, an audio processing/amplifier unit 301 is shown from multiple angles, including a front view 301F, side views 301S, top view 301T, bottom view 301B, and a back view 301B. As shown in the rear view, a in connector 307 is provided to connect audio processing/amplifier unit 301 to a connector 306 in one of the slots 302 in the panel housing as previously described.

Shown in FIGS. 4B-4D are exploded views 400B, 400C and 400C of an illustrative audio processing/amplifier unit 301 in accordance with an embodiment. As shown, a unit body 402 is adapted to cover a front, top and bottom, and removably receive therein a PCB module 403 populated with electronic components and circuits to provide the necessary processor/amplifier functions as earlier described. Unit body 402 receives side panels 404, 406 which are adapted to align with the edges of unit body 402 and to enclose the sides of PCB module 403. Finally, a back panel 408 is adapted to align with edges of the unit body 402, and each of the side panels 404, 406, to enclose the PCB module 403 from the back. Together, unit body 402, side panels 404, 406, and back panel 408 form a substantially complete shell for enclosing and protecting PCB module 403, with the exception of a small aperture which allows a pin connector 307 of the PCB module 403 to be accessible from outside the protective shell.

In an embodiment, unit body 402, side panels 404, 406, and back panel 408 are configured to snap together with suitable interlocking mechanisms provided along the edges that meet, Unit body 402 may also include suitable slots 302 for receiving edges of the PCB module 403 to provide additional structural integrity to the assembled processing/amplifier unit 301.

As will be appreciated, by receiving different types of the PCB module 403 within the enclosure of the as assembled unit 301, the unit 301 may provide different specifications such as amplification power and number of channels.

In an embodiment, one or more of the unit body 402, side panels 404, 406, and back panel 408 are selected to provide sufficient structural strength, heat dissipation properties, and electromagnetic shielding to shield PCB mod 403 from interference from adjacent modules, and also to shield adjacent modules from PCB module 403. Thus, unit body 402 and the side panels 404, 406 may include suitable apertures forming a grill to allow heat generated by PCB module 403 to escape from the enclosure.

In another embodiment, unit body 402 is selected from a material suitable for radiating heat to the surrounding ambient air, and the side panels 404, 406 are selected from a material which shields electromagnetic radiation emitted by the PCB module 403. Examples of possible materials for 404 and 406 are aluminium, and examples of possible materials for 402 and 408 are plastic with RF shielding material painted on the interior surfaces. It will be appreciated that other forms of RF shielding may be used.

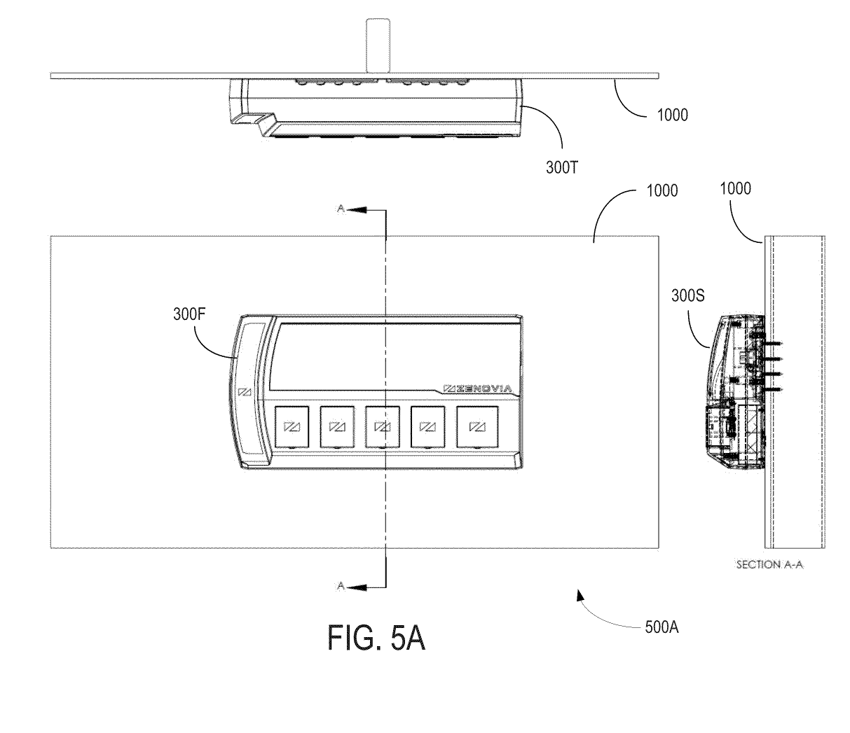

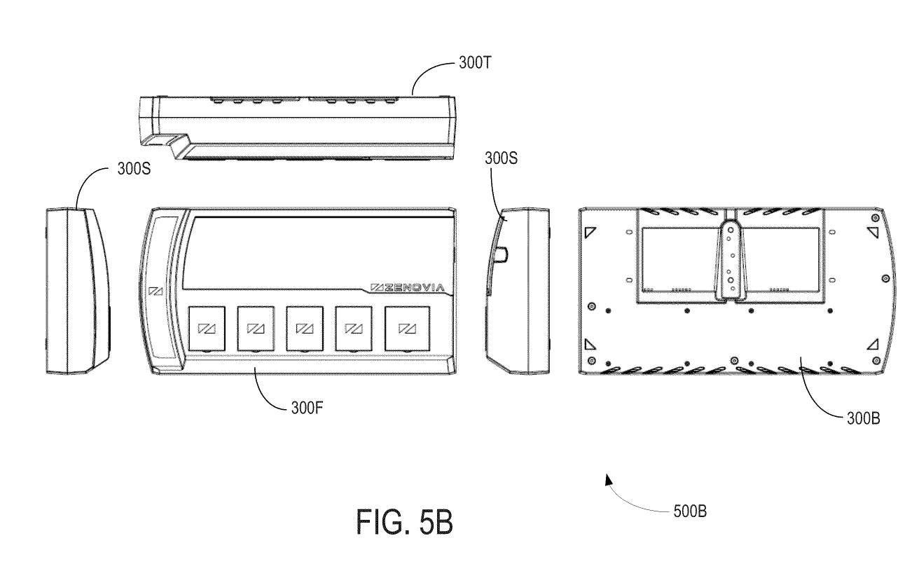

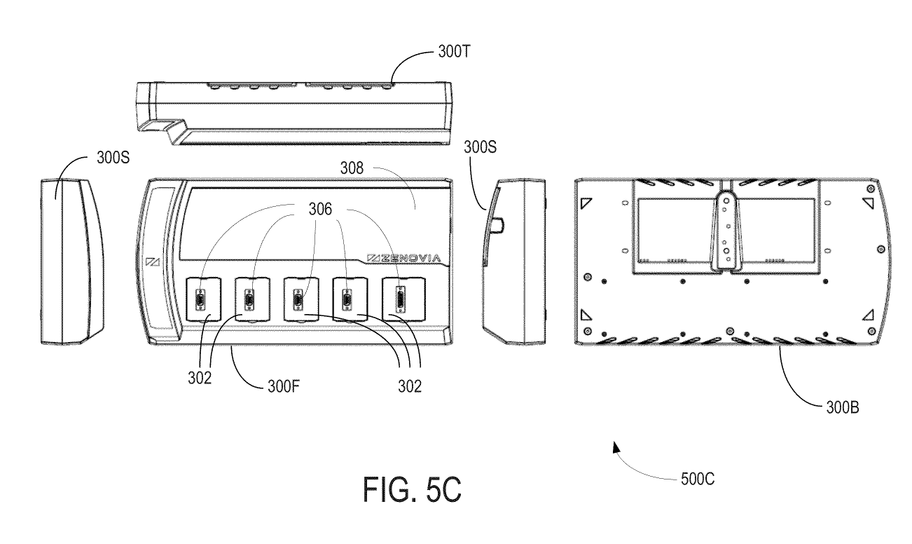

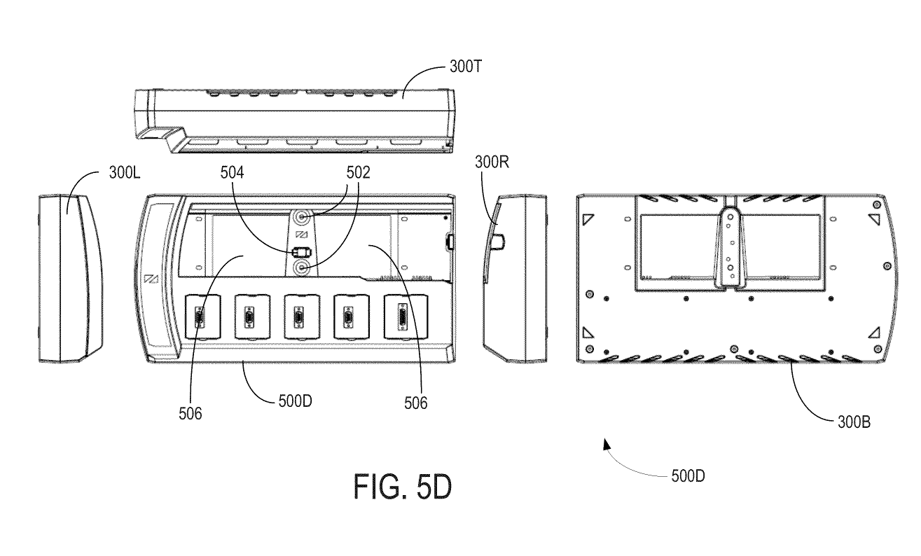

Now referring to FIGS 5A-5E, shown are illustrative detailed views of the processing, amplification and distribution system 300 in accordance with an embodiment. In FIG. 5A, processing, amplification and distribution system 300 is shown in a front view 300F, top view 300T and a cross-sectional side view 3005 taken at A-A. FIG. 5B shows corresponding left and right side views 300S and a rear view 300 of the back panel of processing, amplification and distribution system 300.

As shown in FIG. 5C, front covers have been removed from one or more slots 302, which expose connectors 306. In FIG. 5D, cover panel 308 removed, showing fastening points 502 for fastening the processing, amplification and distribution system 300 (to a wall, for example). A level bubble 504 provided in the processing, amplification and distribution system 300 allows the housing to be levelled horizontally before the panel housing is fastened. Apertures 506 provide access to a all outlet and an opening in a wall, as will now be explained.

With respect to the interchangeable modular nature of the amplifier units, it will be appreciated that the modular units need not be identical to each other, and may be designed to provide different audio configurations and performance characteristics Far example, modular amplifier units intended for surround sound distribution may require that a DTS surround sound decoder be inserted into the signal path within the module prior to the gain stage. The modular amplifier unit may be designed as an integrated module with ail necessary chips, circuits and other IC components, and having a form factor allowing it to be installed within the modular audio amplification and distribution system 200 as described above. Surround sound amplifier units require multiple channels of amplification and may therefore be larger in size and require connectivity to more than one modular slot. For example, a stereo module may fit into a single slot, whereas a 5.1 surround module may require two slots 302, or a larger slot, in the modular audio amplification and distribution system 200. Mono, or other multi-channel audio formats may be supported as well, such as 5.1, 5.2, 7.1, 7.2, 9.1, 9.2, and so on

Given the modular nature of the modular audio amplification and distribution system 200, it is envisaged by the inventor that the modular audio amplification and distribution system 200 could accommodate future developed audio standards to allow for continuous upgrading via interchangeable, modular amplifier units. This may be in response to newly developed audio sources which have not yet been developed, but which may become more widely adopted in the future. With the appropriate wireless transceiver module and necessary software, firmware and hardware modules to decode the signals installed, the modular audio amplification and distribution system 200 may receive any wired or wireless transmissions presently in existence and it is envisaged that the modular audio amplification and distribution system 200 may be upgraded to handle wired or wireless transmissions yet to be developed.

In an embodiment, the modular audio amplification and distribution system 200 need not include any advanced features or controls, if such controls can be provided by a front end controller. For example, the modular audio amplification and distribution system 200 may be controllable via a remote control or wireless device (such as a smart phone or touchpad) to control various functions. As an illustrative example, a control app installed and executed on a smart phone or touch pad may be used to control gain, settings, equalization, effects, compression, power setup (e.g. auto power on signal sensing—off/on), and general system analysis.

In another embodiment, the location of a listener, or the presence of one or more listeners in one or more audio listening zones may be determined by a listener location detection means, such as a motion detector or any other suitable location detection device. Such a listener location detection means may be used by the processor, memory and logic module 230 to actively control which audio speakers 180A-180E are active at any given time.

In another embodiment, the location and identity of a listener may be determined by an object or device the listener is carrying, which may be identified by a near field identification technology such as radio frequency ID (RFID). By determining the location and identity of the listener, processor, memory and logic module 230 can actively modify the audio speakers to which an amplified signal is output such that the audio signal that the listener wishes to listen to can follow the listener automatically between audio listening zones.

In another embodiment, a single processing/amplifier unit 301 may be used with a system 300 having a single slot 302. For example, such a unit 301 can be used with a system 300 adapted for use in an automobile, or on a boat. Thus, the system 300 may not necessarily have a plurality of slots available. Furthermore, unit 301 may have a “plug and play” functionality such that it can be removed from one unit 300 (e.g. in a home), and inserted into another unit 300 (e.g. in an automobile or on a boat).

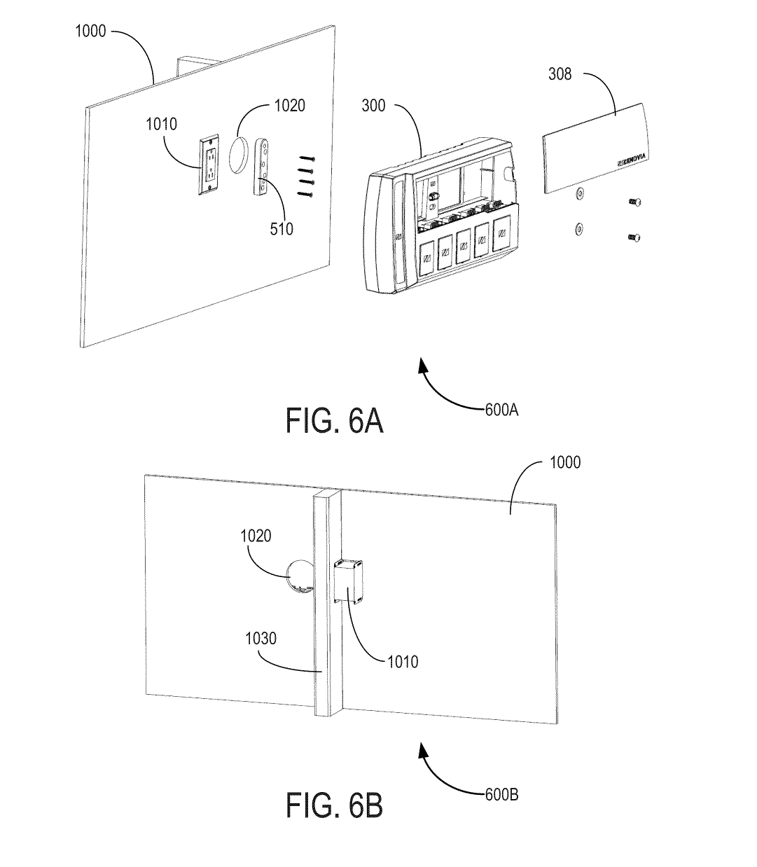

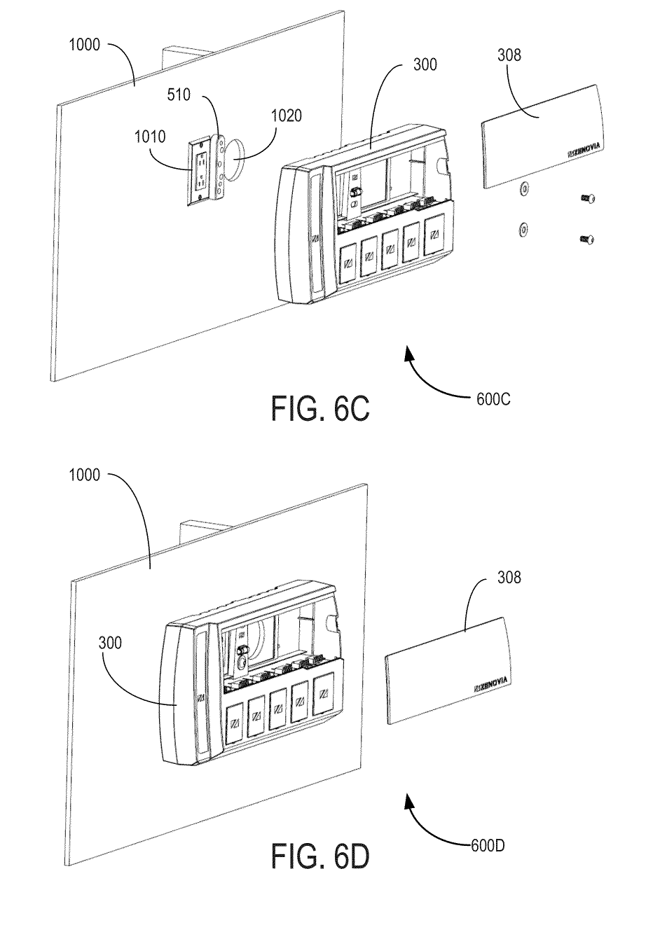

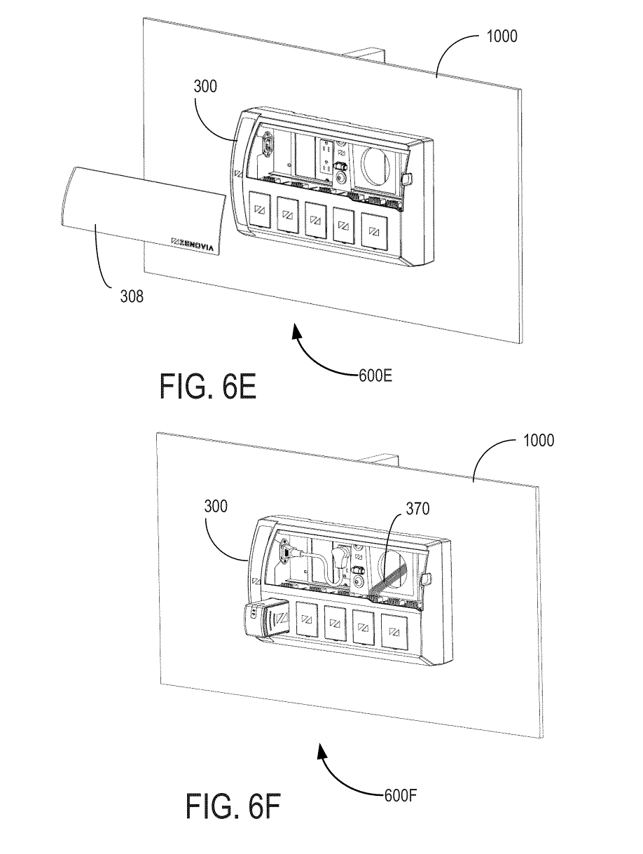

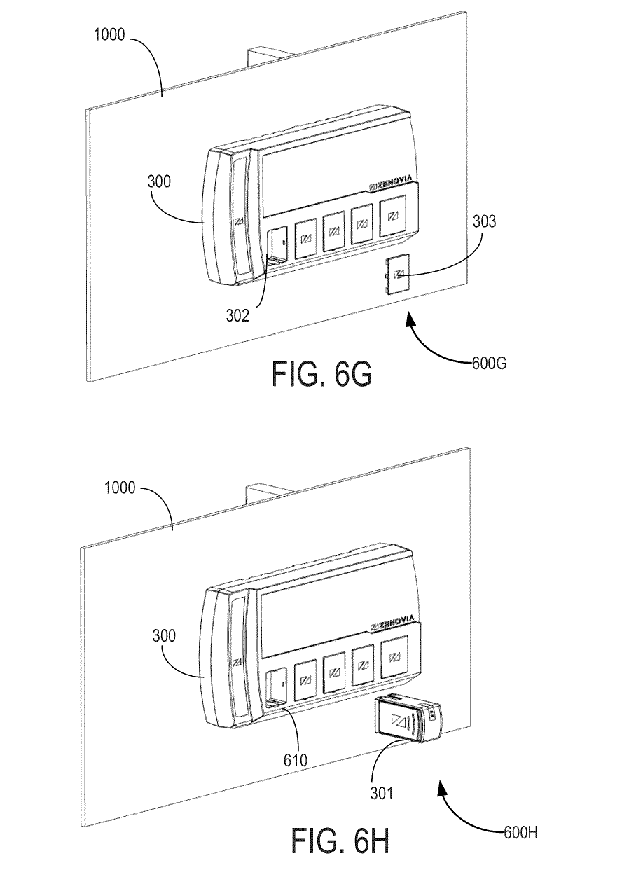

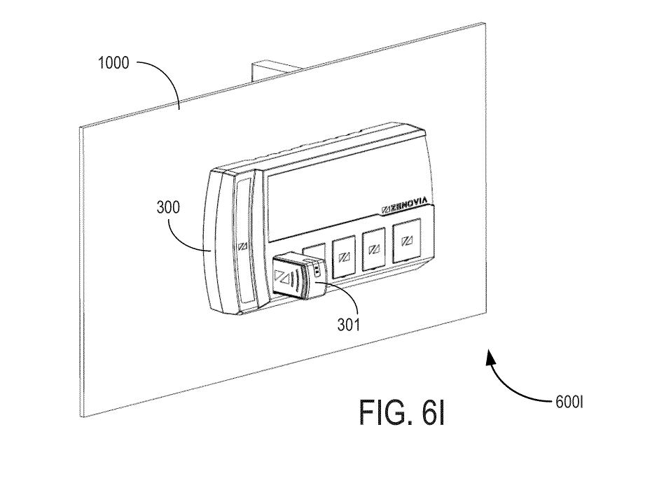

Now referring to FIGS. 6A-6G, shown are illustrative views of the panel housing being mounted to a wall, and audio processor/amplifier modules being inserted in available slots 302 in the panel housing in accordance with an embodiment.

As shown in FIG. 6A, an illustrative section of a wall 1000 includes an electrical outlet 1010 and an opening 1020 cut out from the wall 1000 for access to speaker wiring. As shown, mounting module 510 is first mounted to wall 1000 immediately adjacent to the electrical outlet 1010. FIG. 6B shows a corresponding rear view of the section of wall 1000 showing a stud 1030 adjacent the electrical outlet 1010. Advantageously, the mounting module 510 is suitably configured to allow it to be positioned properly over a stud 1030 adjacent electrical outlet 1010, in order for mounting module 510 to be securely fastened using an appropriate number of fasteners, such as screws, for example. If stud 1030 is on the opposite side of electrical outlet 1010, the mounting module 510 can be mounted on the opposite side of electrical outlet 1010 as the case may be. As shown in FIGS. 6C and 6D, once mounting module 510 is properly secured to a stud adjacent outlet 1010, the processing, amplification and distribution system 300 can be positioned seamlessly over the mounting hardware providing an elegant surface mount such that the electrical outlet 1010 and opening 1020 are both accessible through apertures 506 provided through the back panel 300B of processing, amplification and distribution system 300.

As shown in FIG. 6F, once processing, amplification and distribution system 300 is properly mounted to wall 1000, speaker wires can then be connected to wiring terminals corresponding to each audio listening zone which uniquely allows for the pre-wiring stage to be fully completed and all wiring connections to be finally terminated prior to audio system activation.

As shown in FIG. 6G, processing, amplification and distribution system 300 is now properly mounted with cover panel 308 in place. As shown, a slot cover 303 can be removed to provide access to slot 302, which may receive a processor/amplifier unit. 301 as previously described, which will then activate the corresponding audio listening zone. In essence, an audio circuit will be completed similar to how a circuit breaker completes an electrical circuit in the standard home electrical panel system.

For example, a processor/amplifier unit 301 may be aligned with slot 302 as shown in FIG. 6H, and inserted into slot 302 as shown in FIG. 6H. With the installation complete, the processing, amplification and distribution system 300 is ready for receiving a plurality of processor/amplifier units 301 as may be desired, and for amplifying audio on-demand for a plurality of audio listening zones.

Thus, in an aspect, there is provided a modular system for processing, amplification and distribution of audio signals, comprising: a panel or housing having one or more slots configured to receive one or more modular audio processor/amplifier units therein; and a connector provided in each slot for connecting the one or more modular audio processor/amplifier units upon insertion of a unit into the slot; wherein the one or more modular audio processor/amplifier units inserted into the plurality of slots are connected to a power source thereby, and to corresponding listening zones associated with each slot.

In an embodiment, the connector provided in each slot is adapted to provide a power connection, a ground connection, and one or more signal connections for each modular audio processor/amplifier unit connected thereto.

In another embodiment, the panel or housing further comprises a common power connection for all modular audio processor/amplifier units inserted into the plurality of slots.

in another embodiment, the plurality of slots are sized identically to interchangeably receive any one of one or more identically sized modular audio processor/amplifier units therein.

In another embodiment, the plurality of slots are sized differently to receive only certain appropriately sized modular audio processor/amplifier units therein.

In another embodiment, the panel or housing further comprises a plurality of speaker cable connection points, each speaker cable connection point corresponding to one slot.

In another embodiment, each speaker cable connection point is provided adjacent a slot, such that speaker cables connected to the speaker cable connection point can readily be associated with a slot.

In another embodiment, the plurality of speaker cable connection points are adapted to receive re-installed speaker wires from a plurality of listening zones, such that the modular system can provide processing, amplification and distribution of audio signals for all listening zones.

In another embodiment, the system further comprises a mounting module for mounting the modular system to a surface.

In another embodiment, the mounting module is adapted to mount the modular system to a wall adjacent an electrical outlet.

In another embodiment, the modular system panel or cabinet further comprises a level bubble for levelling the modular system for mounting.

In another embodiment, the modular system panel or cabinet further comprises removable covers for each slot.

In another embodiment, the modular system panel or cabinet further comprises a removable cover panel for access to a plurality of speaker cable connection points.

In another embodiment, the modular system panel or cabinet further comprises apertures in a back panel for access to an electrical outlet and to an opening in a wall when the modular system is mounted to a wall.

In another aspect, there is provided a wall mountable, apparatus for an audio processing, amplification and distribution system, comprising: one or more slots configured to receive one or more modular audio processor/amplifier units therein; and a connector provided in each slot for connecting the one or more modular audio processor/amplifier units upon insertion of a unit into the slot; wherein the one or more modular audio processor/amplifier units inserted into the plurality of slots are connected to a power source thereby, and to corresponding listening zones associated with each slot.

In an embodiment, the connector provided in each slot is adapted to provide a power connection, a ground connection, and one or more signal connections for each modular audio processor/amplifier unit connected thereto.

In another embodiment, the wall mountable panel or housing further comprises a common power connection for all modular audio processor/amplifier units inserted into the plurality of slots.

In another embodiment, the plurality of slots are sized identically to interchangeably receive any one of one or more identically sized modular audio processor/amplifier units therein.

In another embodiment, the plurality of slots are sized differently to receive only certain appropriately sized modular audio processor/amplifier units therein

In another embodiment, the wall mountable panel or housing further comprises a plurality of speaker cable connection points, each speaker cable connection point corresponding to one slot.

In another embodiment, the one or more speakers in the one or more listening zones are self-powered speakers which are connected wirelessly to the audio processor/amplifier panel, such that there is no need to connect the speakers to the amplifier speaker connections using speaker wire. Rather, in this embodiment, the system pairs each wireless speaker to a digital line output which bypasses the amplification stage of the one or more audio processor/amplifier units. Line outputs from one or more audio processor/amplifier units are connected to a wireless audio signal transmitter, and received by one or more of the self-powered, wirelessly connected speakers.

In another embodiment, the one or more speakers in the one or more listening zones are connected conventionally to the audio processor/amplifier panel or housing using speaker wire. The audio processor/amplifier panel or housing may accept one or more interchangeable modular audio processor/amplifier units to activate and enable audio playback on the one or more speakers in the one or more listening zones.

In another embodiment, the one or more interchangeable modular audio processor/amplifiers units may be configured to be normally on standby in the absence of a wake signal or wireless audio input signal, and to process and optionally amplify any wireless audio input signals on-demand upon receipt of a wake signal or wireless audio signal directed or addressed to the one or more modular audio processor/amplifier units. The processed audio signals are then distributed to one or more speakers in one or more listening zones.

While the above description provides examples of one, or more systems and/or apparatuses, it will be appreciated that other systems and/or apparatuses may be within the scope of the present description as interpreted by one of skill in the art.

1. A modular system for processing, amplification and distribution of audio signals, comprising:
a panel or housing having one or more slots configured to receive one or more modular audio processor/amplifier units therein; and
a connector provided in each slot for connecting the one or more modular audio processor/amplifier units upon insertion of a unit into the slot;
wherein the one or more modular audio processor/amplifier units inserted into the plurality of slots are connected to a power source thereby, and to corresponding listening zones associated with each slot.

2. The modular system of claim 1, wherein the connector provided in each slot is adapted to provide a power connection, a ground connection, and one or more signal connections for each modular audio processor/amplifier unit connected thereto.

3. The modular system of claim 1, wherein the panel or housing further comprises a common power connection for all modular audio processor/amplifier units inserted into the plurality of slots.

4. The modular system of claim 1, wherein the plurality of slots are sized identically to interchangeably receive any one of one or more identically sized modular audio processor/amplifier units therein.

5. The modular system of claim 1, wherein the plurality of slots are sized differently to receive only certain appropriately sized modular audio processor/amplifier units therein.

6. The modular system of claim 1, wherein the panel or housing further comprises a plurality of speaker cable connection, points, each speaker cable connection point corresponding to on slot.

7. The modular system of claim 6, wherein each speaker cable connection point is provided adjacent a slot, such that speaker cables connected to the speaker cable connection point can readily be associated with a slot.

8. The modular system of claim 6, wherein the plurality of speaker cable connection points are adapted to receive pre-installed speaker wires from a plurality of listening zones, such that the modular system can provide processing, amplification and distribution of audio signals for all listening zones.

9. The modular system of claim 1, further comprising a mounting module for mounting the modular system to a surface.

10. The modular system of claim 9, wherein the mounting module is ad adapted to mount, the modular system to a wall adjacent an electrical outlet.

11. The modular system of claim 9, wherein the modular system panel or cabinet further comprises a level bubble for levelling the modular system for mounting.

12. The modular system of claim 9, wherein the modular system panel or cabinet further comprises removable covers for each slot.

13. The modular system of claim 9, wherein the modular system panel or cabinet further comprises a removable cover panel for access to a plurality of speaker cable connection points.

14. The modular system of claim 9, wherein the modular system panel or cabinet further comprises apertures in a back panel for access to an electrical outlet and to an opening in a wall when the modular system is mounted to a wall.

15. A wall mountable apparatus for an audio processing, amplification and distribution system, comprising:
one or more slots configured to receive one or more modular audio processor/amplifier units therein; and
a connector provided in each slot for connecting the one or more modular audio processor/amplifier units upon insertion of a unit into the slot;
wherein the one or more modular audio processor/amplifier units inserted into the plurality of slots are connected to a power source thereby, and to corresponding listening zones associated with each slot.

16. The wall mountable apparatus of claim 15, wherein the connector provided in each slot is adapted to provide a power connection, a ground connection, and one or more signal connections for each modular audio processor/amplifier unit connected thereto.

17. The wall mountable apparatus of claim 15, further comprising a common power connection for all modular audio processor/amplifier units inserted into the plurality of slots.

18. The wall mountable apparatus of claim 15, wherein the plurality of slots are sized identically to interchangeably receive any one of one or more identically sized modular audio processor/amplifier units therein.

19. The wall mountable apparatus of claim 15, wherein the plurality of slots are sized differently to receive only certain appropriately sized modular audio processor/amplifier units therein.

20. The wall mountable apparatus of claim 15, further comprising a plurality of speaker cable connection points, each speaker cable connection point corresponding to one slot.
